(19) United States
(12) Patent Application Publication
(10) Pub. No.: US 2009/0162723 A1
(43) Pub. Date: Jun. 25, 2009

(54) Integrated Single-Chamber Solid Oxide Fuel Cells

(76) Inventor: Zhongliang Zhan, King of Prussia, PA (US)

Correspondence Address: Zhongliang Zhan, 251 West Dekalb Pike, Apt. C-302, King of Prussia, PA, 1940, US

(21) Appl. No.: 11/960,913

(22) Filed: Dec. 20, 2007

(51) Int. Cl. H01M 8/10; B29C 35/02; B05D 1/02; B44C 1/22

(52) U.S. Cl. 429/33; 264/614; 427/58; 429/30; 216/41; 101/129

(57) ABSTRACT

A single-chamber solid oxide fuel cell (SC-SOFC) system includes an electrolyte having a first surface and a second surface, a plurality of cell units on the first surface of the electrolyte, and a plurality of interconnects electrically connecting the plurality of the cell units. Each of the cell units includes an elongate anode current collector, a plurality of spaced apart anodes connected to a side of the anode current collector, an elongate cathode current collector, a plurality of spaced apart cathodes connected to a side of the cathode current collector. The plurality of cathodes and anodes are substantially in parallel and are interdigitated, forming a plurality of anode-cathode pairs. A plurality of barriers are positioned between adjacent anodes and cathodes. A method of producing the SC-SOFC system is also provided.

### TECHNICAL FIELD

This invention relates in general to fuel cells, and in particular, to single-chamber solid oxide fuel cells and methods of making same.

### BACKGROUND

Solid oxide fuel cells (SOFCs) are electrochemical conversion devices that include a solid-phase electrolyte and convert various fuel sources directly into electrical energy at elevated temperatures from 600° C. to 1000° C. The high operating temperature allows the direct use of various hydrocarbon fuels without the need for expensive noble metal catalysts. Conventional SOFCs are designed as a dual-chamber system, separating the fuel and oxidant flows to the anode and cathode, respectively. However, manufacturing cost and robustness of dual-chamber solid oxide fuel cells have been the main challenge to rapid commercialization. A promising alternative is the single-chamber solid oxide fuel cell (SC-SOFC) system, where both the anode and the cathode are exposed to the same fuel-oxidant gas mixtures. The operation of SC-SOFCs relies on the difference in the selectivity of the cathode and the anode for the fuel oxidation reactions. SC-SOFC systems avoid many manufacturing challenges associated with conventional SOFC systems, and have shown optimal performance between 500° C. and 800° C. SC-SOFC design reduces the need for high temperature sealing and complicated manifold structures.

There are two types of geometries for SC-SOFCs: one type has the anode and cathode positioned on the opposite sides of the electrolyte, which is the same arrangement as in the conventional dual-chamber duel cells; the other type has the two electrodes positioned on the same side of the electrolyte. SC-SOFCs can be relatively easily and compactly stacked, thus making it a good candidate for small- or micro-scale power generation for portable applications.

### SUMMARY

The present invention provides a fuel cell which includes an electrolyte having a first surface and a second surface, an anode on the first surface of the electrolyte, a cathode on the first surface of the electrolyte and being spaced apart from the anode with a predetermined distance therebetween, and a barrier on the first surface between the anode and the cathode. The barrier may be made of a material that is inert to a fuel-oxidant mixture. In a preferred embodiment, the barrier is made of an electrolyte material.

In some embodiments, the fuel cell further includes a mixed ionic and electronic conductor on the second surface of the electrolyte. The mixed ionic and electronic conductor may be lanthanum strontium cobalt ferric oxide (LSCF), or barium strontium cobalt ferric oxide (BSCF).

In some embodiments, the electrolyte consists of two or more layers that are made of different electrolyte materials. In a preferred embodiment, one of the two or more electrolyte layers is made of doped ceria and is positioned adjacent to the anode and the cathode.

In some embodiments, the fuel cell may further include a support on which the electrolyte is formed. In such embodiments, the support may be porous, and the electrolyte may include multiple layers made of different electrolyte materials.

In another embodiment, the present invention provides a single-chamber solid oxide fuel cell (SC-SOFC) system, which includes an electrolyte having a first surface and a second surface, a plurality of cell units on the first surface of the electrolyte, and a plurality of interconnects electrically connecting the plurality of the cell units. Each of the cell units includes an elongate anode current collector, a plurality of spaced apart anodes connected to a side of the anode current collector, an elongate cathode current collector, a plurality of spaced apart cathodes connected to a side of the cathode current collector. The plurality of cathodes and anodes are substantially in parallel and are interdigitated, forming a plurality of anode-cathode pairs. The SC-SOFC includes a plurality of barriers each being positioned between an adjacent anode and cathode.

In another aspect, the present invention provides a method of making a single-chamber solid oxide fuel cell stack. The method comprises the steps of providing a substrate of an electrolyte material having a first surface and a second surface, applying a plurality of cell units on the first surface of the substrate, and co-sintering the substrate and the plurality of cell units in a same step.

The substrate may be prepared by ceramic processing. The plurality of cell units may be applied by spray-coating, screen-printing, microtransfer molding, microcontact printing, micromolding in capillaries (MIMIC), or vacuum-assisted microfluidic lithiography.

The co-sintering step may be carried out at a temperature ranging from 1000° C. to 1500° C. Preferably, the co-sintering step is carried out at a temperature ranging from 1100° C. to 1250° C.

### BRIEF DESCRIPTION OF THE DRAWINGS

These and various other features and advantages of the present invention will become better understood upon reading of the following detailed description in conjunction with the accompanying drawings and the appended claims provided below, where:

FIG. 1A is a schematic top view of a single-chamber solid oxide fuel cell stack including a plurality of cell units in accordance with one embodiment of the invention;

FIG. 1B is a schematic top view of a cell unit comprising interdigitated anodes and cathodes in accordance with one embodiment of the invention;

FIG. 1C is a schematic side cross-sectional view of the cell unit illustrated in FIG. 1B in accordance with one embodiment of the invention;

FIG. 2A is a schematic top view of a single-chamber solid oxide fuel cell stack including a plurality of cell units in accordance with one embodiment of the invention;

FIG. 2B is a schematic top view of a cell unit comprising interdigitated anodes, cathodes, and barriers in accordance with one embodiment of the invention;

FIG. 2C is a schematic side cross-sectional view of the cell unit illustrated in FIG. 2B in accordance with one embodiment of the invention; and

FIGS. 3A-3D illustrate exemplary substrates in accordance with some embodiments of the present invention.

### DETAILED DESCRIPTION OF VARIOUS EMBODIMENTS

Various embodiments of the present invention are described hereinafter with reference to the figures. It should be noted that the figures are not drawn to scale and elements of similar structures or functions are represented by like reference numerals throughout the figures. It should also be noted that the figures are only intended to facilitate the description of specific embodiments of the invention. They are not intended as an exhaustive description of the invention or as a limitation on the scope of the invention. In addition, an aspect described in conjunction with a particular embodiment of the present invention is not necessarily limited to that embodiment and can be practiced in any other embodiments of the present invention. For instance, various embodiments of the invention are described with planar solid oxide fuel cells. It will be appreciated that the claimed invention can also be used for tubular solid oxide fuel cells.

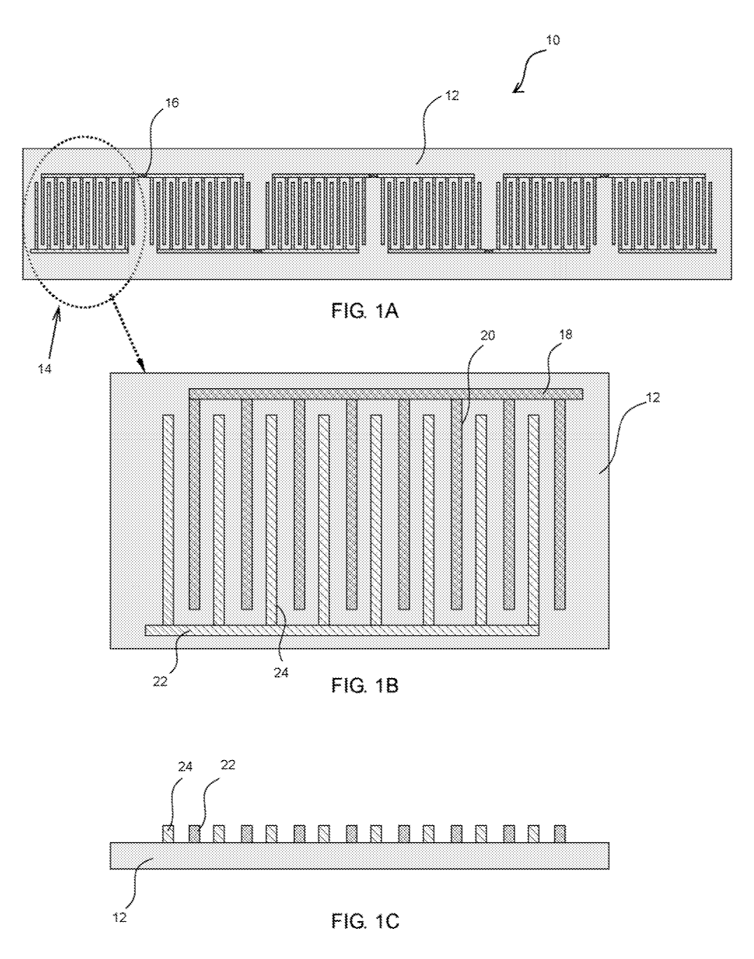

FIG. 1A schematically illustrates an integrated single-chamber solid oxide fuel cell (SC-SOFC) stack 10 formed on a substrate 12. As shown, the substrate 12 is substantially planar, and six sub-cells or cell unites 14 are formed on the same side surface of the planar substrate 12. It is to be understood that the integrated SC-SOFC stack 10 may include any number of cell unites to produce an electrical power level useful for a particular end use, and the SC-SOFC stack may be fabricated on a tubular substrate as well as a planar substrate. Interconnects 16 electrically connect the plurality of the cell units 14. The interconnect 16 may be metals such as silver, platinum etc., or electronically conductive ceramics such as strontium doped lanthanum chromites.

As shown in FIG. 1B, each of the cell units 14 includes an elongate anode current collector 18 and a plurality of anodes 20 connected to one side of the anode current collector 18 along the length of the collector 18. The anodes 20, shown as being linear and in parallel, have a length ranging from 0.1 to 100000 microns, preferably from 100 to 10000 microns, and have a substantially constant width along their length ranging from 0.1 to 10000 microns and preferably from 100 to 1000 microns. The anodes 20 are spaced apart among each other along the length of the current collector 18 at a distance ranging from 0.3 to 30000 microns and preferably from 300 to 3000 microns. The anodes 20 may be perpendicularly connected to the current collector 18. Alternatively, the anodes 20 may be connected to the current collector 18 at an oblique angle. The thickness of the anodes 20 ranges from 0.1 to 1000 microns and preferably approximately from 1 to 50 microns.

Each cell unit 14 also includes an elongate cathode current collector 22 and a plurality of cathodes 24. The configuration of the cathode current collector 22 and cathodes 24 is similar to the configuration of the anode current collector 18 and anodes 20. Specifically, the elongate cathode current collector 22 is substantially parallel to the anode current collector 18. A plurality of cathodes 24 are connected to one side of the current collector 22 in spaced apart positions along the length of the current collector 22. The separation distance between adjacent cathodes 24 corresponds to the separation distance of adjacent anodes 20. The cathodes 24, shown as being linear and in parallel, have a length, a width, and a thickness corresponding to the length, width, and thickness of the anodes 20. The cathodes 24 may be perpendicularly connected to the current collector 22. Alternatively, the cathodes 24 may be connected to the current collector 22 at an oblique angle.

The plurality of anodes 20 and the plurality cathodes 24 are interdigitated at midpoint lines of adjacent anodes 20 and anodes 24, forming a pattern that an anode alternates with a cathode. A plurality of anode-cathode pairs are formed with a distance between an adjacent anode and cathode ranging from 0.1 to 10000 microns, and preferably from 100 to 1000 microns.

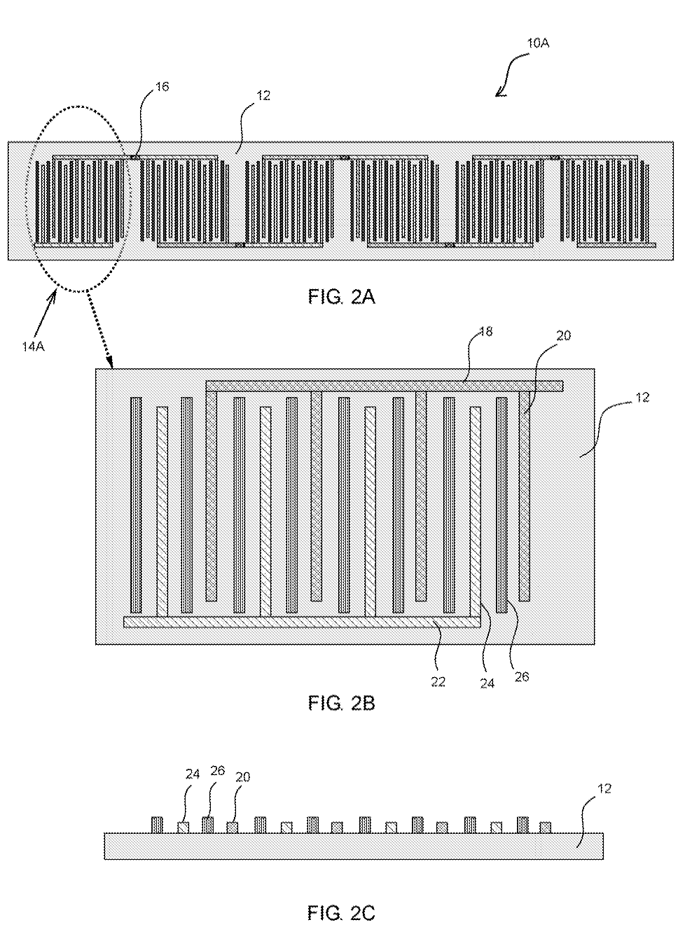

FIGS. 2A-2C schematically illustrates a single-chamber solid oxide fuel cell stack 10A in accordance with another embodiment of the invention. A plurality of cell unites 14A are formed on the same side surface of a substantially planar substrate 12. Interconnects 16 electrically connect the cell units 14A to form an integrated fuel cell stack 10A. In comparison with the SC-SOFC stack 10 illustrated in FIGS. 1A-1C, each cell unit 14A shown in FIG. 2A includes a barrier 26 between adjacent anode 20 and cathode 24. The barriers 26 are substantially linear and in parallel with the anode 20 and/or cathode 24. The barriers 26 have a substantially constant width along their length, which is similar to or slightly greater than the length of the anodes 20 and/or cathodes 24. The barriers 26 have a thickness that is similar to or slightly greater than the thickness of the anode 20 and/or cathode 24. The barriers 26 between adjacent electrodes advantageously prevent the turbulence gas flow between adjacent electrodes, which would otherwise lower the oxygen partial pressure difference due to the very close distance between the anodes and cathodes. The barriers 26 may be made of an inert material such as alumina and cordierite. The barriers 26 may also be made of electrolyte materials such as yttrium-stabilized zirconia (YSZ), scandium-stabilized zirconia (ScSZ), gadolinium doped ceria (GDC), samarium doped ceria (SDC), and lanthanum strontium gallate magnesite (LSGM). The barriers 26 may be porous or dense. As used herein and hereafter, the term “porous” in the context of barriers, electrolyte, anodes and cathodes, refers to a material that contains pores or voids into which a gas may diffuse. The term “dense” refers to a material that is impermeable to gases.

The substrate 12 may be made of any suitable materials. In some embodiments, the substrate 12 consists of a single layer of an electrolyte material. In some embodiments, the substrate 12 is a combination of two or more layers of different electrolyte materials. In some embodiments, the substrate 12 is formed of an inert support and one or more layers of electrolyte materials on top of the inert support. The thickness of the substrate 12 may be chosen to provide mechanic support for the cell units. By way of example, the thickness of the substrate may range from 0.1 mm to 5 mm and preferably from 0.2 mm to 2 mm.

The electrolyte may be of any suitable materials that transport oxygen ions. By way of examples, the electrolyte may be formed from yttrium-stabilized zirconia (YSZ), scandium-stabilized zirconia (ScSZ), gadolinium doped ceria (GDC), samarium doped ceria (SDC), lanthanum strontium gallate magnesite (LSGM), apatite-type oxide ion conductors such as La₁₀₋ₓ(Si/Ge)₆O_{26+z}, La₆Bi₂M₂Ge₆O₂₆ (M=Mg, Sr, Ba) and La₈₋ₓBi₂Ge₅GaO_{26+y}.

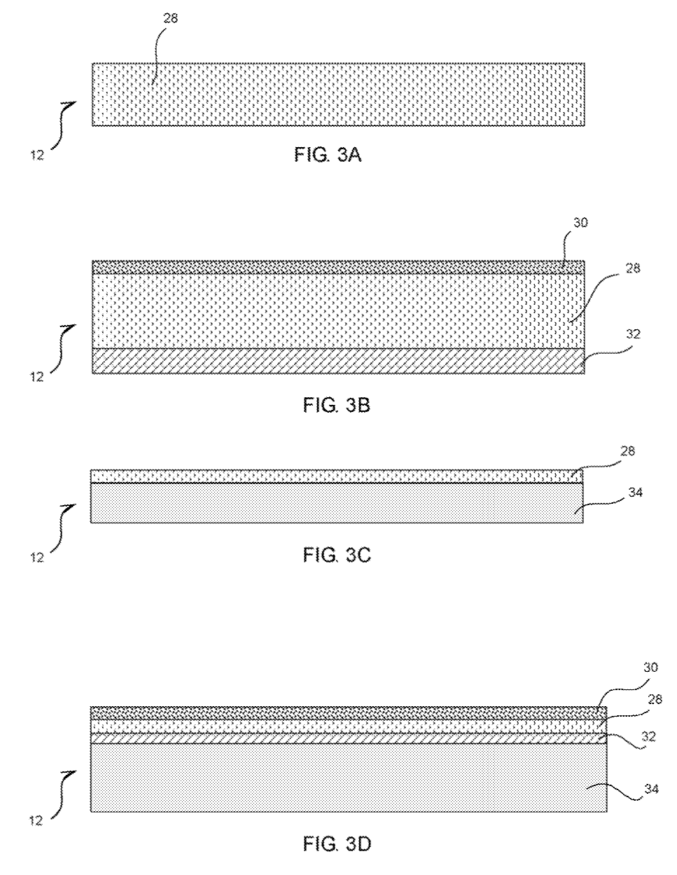

FIGS. 3A-3D schematically illustrate exemplary substrates in accordance with some embodiments of the present invention. As shown in FIG. 3A, the substrate 12 consists of a single layer of an electrolyte material 28 such as yttrium-stabilized zirconia (YSZ), gadolinium doped ceria (GDC), samarium doped ceria (SDC), and lanthanum strontium gallate magnesite (LSGM). As shown in FIG. 3B, the substrate is formed of multiple layers of different electrolyte materials 28, 30, and 32. For example, various combinations of yttrium-stabilized zirconia (YSZ), gadolinium doped ceria (GDC), samarium doped ceria (SDC), and lanthanum strontium gallate magnesite (LSGM) may be used to form the substrate. By way of example, doped ceria such as gadolinium doped ceria (GDC), or samarium doped ceria (SDC) layer is preferably positioned between the electrodes and the other electrolyte layers to increase the electrode reactions or to prevent undesirable chemical reactions between the electrodes and the electrolyte.

In a preferred embodiment shown in FIG. 3C, the substrate 12 comprises a bulk support 34 and a thin electrolyte layer 28 at varied magnitude of thickness from microns to millimeter. The bulk support 34 may be formed of an inert material such as alumina (Al₂O₃) and cordierite. The bulk support 34 may also be formed of a mixed ionic and electronic conductor such as lanthanum strontium cobalt ferric oxide (LSCF), barium strontium cobalt ferric oxide (BSCF) and the like. The mixed ionic and electronic conductor may have higher oxygen ionic conductivities than the electrolyte materials at comparable temperatures. The bulk support 34 may be dense or may have a honey-comb or a micro porous structure. The bulk support 34 may also be mixed with the other electrolyte materials. A substrate having a bulk support and one or more thin electrolyte layers may provide improved resistance toward thermal shocks to prevent the fuel cell stack from cracking in rapid thermal cycling between the operating temperature and room temperature.

In a preferred embodiment shown in FIG. 3D, the substrate 12 includes a bulk support 34 and multiple electrolyte layers 28, 30, 32 at varied magnitude of thickness from microns to millimeters. The bulk support 34 may be formed of an inert material such as alumina (Al₂O₃), or a mixed ionic and electronic conductor such as lanthanum strontium cobalt ferric oxide (LSCF), barium strontium cobalt ferric oxide (BSCF) and the like. The bulk support 34 may be dense or may have a honey-comb or a micro porous structure. In a preferred embodiment, one of the multiple electrolyte layers is a doped ceria on top of the substrate 12, or in contact with anodes 20 and cathodes 24.

Returning to FIGS. 1A-1C and FIGS. 2A-2C, the anodes 20 and cathodes 24 and current collectors 18, 20 may be formed of any suitable materials as desired for specific applications. In general, the materials for the anodes 20 and cathodes 24 are chosen to be selective to corresponding electrode reactions. Specifically, the anodes 20 should be electrochemically active for oxidation of the fuel but inert to oxygen reduction. On the other hand, the cathodes 24 should be electrochemically active for oxygen reduction but inert to fuel oxidation. The anodes 20 and cathodes 24 are generally porous to allow fuel-oxidant gas transport to the reaction site for corresponding electrode reaction.

By way of example, the anodes 20 may be formed of a metal oxide mixed with an electrolyte material such as YSZ, ScSZ, SDC, GDC, or LSGM. In some embodiments, the anodes 20 are formed of nickel oxide mixed with doped ceria such as SDC or GDC. The nickel oxide content in the anodes may range from about 30 to 80 percent by weight, and preferably from 50 to 60 percent by weight. In some embodiments, the anodes 20 may be an electronically conductive oxide mixed with or without an electrolyte material. In some embodiments, nanoparticles of noble metals may be incorporated into the porous anodes 20 to enhance the catalytic activities for fuel partial oxidation reactions.

The cathodes 24 may be made of an electronic conductor, or a mixed ionic and electronic conductor. The porous cathodes 24 may also contain an electrolyte material such as YSZ, ScSZ, SDC, GDC, or LSGM. By way of example, an electronic conductor lanthanum strontium manganite (LSM) may be used to form the porous cathodes 24. Alternatively, a mixed ionic and electronic conductor such as lanthanum strontium cobalt ferric oxide (LSCF), barium strontium cobalt ferric oxide (BSCF) and the like mixed with an electrolyte material such as doped ceria or SDC or GDC, may be used to form the porous cathodes 24. The content of the electronically conductive oxide or mixed ionic and electronic conductor in the cathode may range from about 30 to about 80 percent by weight, and preferably from about 50 to 70 percent by weight.

The anode and cathode current collectors 18, 22 may be formed of a same or different material. By way of example, the current collectors 18, 22 may be made of a metal oxide mixed with an electrolyte material such as YSZ, ScSZ, SDC, GDC, or LSGM, an electronic conductor such as lanthanum strontium manganite (LSM), a mixed ionic and electronic conductor such as lanthanum strontium cobalt ferric oxide (LSCF), barium strontium cobalt ferric oxide (BSCF) and the like mixed with an electrolyte material such as doped ceria or SDC or GDC, or even some other electronically conductive ceramics such as strontium doped lanthanum chromites.

The method of making the single-chamber solid oxide fuel cell stack in accordance with the invention includes the steps of providing a substrate comprising an electrolyte material, applying a plurality of cell units including anodes and cathodes, current collectors, and optionally barriers on a same surface of the electrolyte, and co-sintering the substrate, the electrodes, the current collectors and optionally the barriers, in a same or single step.

The substrate may be prepared by conventional ceramic processing techniques, such as tape casting or extrusion. For example, the powder material for a substrate may be mixed with a suitable solvent, dispersant and binder for a time period such as about thirty hours. The resulting slurry is then cast or extruded to form tapes with a thickness from 5 microns to 1 mm, and preferably from 30 microns to 0.2 mm. For a substrate comprising multiple electrolyte layers, these different tapes may be stacked and iso-statically laminated at a suitable pressure and temperature, such as at a pressure of thousands of pounds per square inch and at a temperature from about 40° C. to 90° C.

The porous anodes, cathodes, current collectors, and barriers may be applied and patterned on the same surface of the substrate by various techniques known in the art. By way of example, spray-coating of colloidal, slurry screen-printing, and soft lithography techniques including microtransfer molding, microcontact printing, micromolding in capillaries (MIMIC) and vacuum-assisted microfluidic lithiography may be used to apply and pattern the fuel cell stack. To simplify the description of the invention, the above listed known techniques are not described in great detail. Lai et al. describe methods of spray-coating of colloidal and slurry screen-printing in “Effect of Cell Width on Segmented-in-Series SOFCs”, Electrochemical and Solid-State Letters, 7 (4): A78-A81 (2004). Xia et al. describe various soft lithography techniques in “Soft lithography”, Angewandte Chemie International Edition, 37: 551-575 (1998). Lai et al. and Xia et al. are incorporated herein in their entirety. Lai et al. and Xia et al. are incorporated herein by reference to the extent of general knowledge. The colloidal or slurry includes the respective powder materials for electrodes, current collectors, and barriers. Ingredients such as dispersant (e.g., fish oil), binder (e.g., polyvinyl butyral and ethyl cellulose) and solvents (e.g., ethanol, terpinol oil) may be used in forming the colloidal or slurry.

The patterned multiple components including the substrate, anodes, cathodes, current collectors, and optionally barriers, are co-sintered at a temperature from 1000° C. to 1500° C., and preferably from 1100° C. to 1250° C., forming a plurality of cell units. Finally, interconnects are applied to electrically connect the plurality of cell units to form an integrated single-chamber fuel cell stack.

The present invention provides new methods to fabricate a highly compacted SC-SOFC stack with striped electrodes on the same side of an electrolyte or substrate. The new methods significantly reduce the manufacturing cost and improve the robustness of the fuel cell. Barrier layers may be disposed between adjacent anodes and cathodes to prevent or minimize the turbulence gas flow. A mixed ionic and electronic conductor may be formed on the opposite side of the electrolyte to reduce the pure ohmic resistance of the cells. The SC-SOFC stacks made according to the present invention have enhanced resistance to thermal shock, rapid heating/cooling cycle, and increased tolerance to crack and pinholes in the solid electrolyte membrane. Various fuels may be used in the SC-SOFC system of the present invention including hydrogen, CO, hydrocarbons such as methane, ethane, propane, butane, pentane, methanol, ethanol, natural gas or gasoline, and mixtures thereof.

From the foregoing it will be appreciated that although specific embodiments of the invention have been described herein for purposes of illustration, various modifications may be made without deviating from the spirit and scope of the invention.

What is claimed is:

1. A fuel cell comprising:
an electrolyte having a first surface and a second surface;
an anode on the first surface of the electrolyte;
a cathode on the first surface of the electrolyte, said cathode being spaced apart from said anode with a predetermined distance therebetween; and
a barrier on the first surface between said anode and said cathode.

2. The fuel cell of claim 1 further comprising a mixed ionic and electronic conductor on the second surface of the electrolyte.

3. The fuel cell of claim 2 wherein said mixed ionic and electronic conductor comprises lanthanum strontium cobalt ferric oxide (LSCF), or barium strontium cobalt ferric oxide (BSCF).

4. The fuel cell of claim 1 wherein said electrolyte comprises two or more layers that are made of different electrolyte materials.

5. The fuel cell of claim 4 wherein one of said two or more electrolyte layers is made of doped ceria that is positioned adjacent to said anode and said cathode.

6. The fuel cell of claim 1 further comprising a support on which the electrolyte is formed.

7. The fuel cell of claim 6 wherein said support is porous, and said electrolyte comprises multiple layers made of different electrolyte materials.

8. The fuel cell of claim 1 wherein said barrier is made of a material that is inert to a fuel-oxidant mixture.

9. The fuel cell of claim 1 wherein said barrier is made of an electrolyte material.

10. The fuel cell of claim 1 wherein said anode, cathode, and barrier are substantially linear and in parallel.

11. The fuel cell of claim 10 wherein said barrier has a thickness greater than a thickness of the anode or cathode.

12. A single-chamber solid oxide fuel cell system, comprising:
an electrolyte having a first surface and a second surface;
a plurality of cell units on the first surface of the electrolyte, wherein each of said cell units comprises:
an elongate anode current collector; a plurality of spaced apart anodes connected to a side of the anode current collector, said plurality of anodes being substantially in parallel with a predetermined distance between adjacent anodes;
an elongate cathode current collector; a plurality of spaced apart cathodes connected to a side of the cathode current collector, said plurality of cathodes being substantially in parallel with a predetermined distance between adjacent cathodes, wherein the plurality of the cathodes are interdigitated with the plurality of anodes, forming a plurality of anode-cathode pairs; and
a plurality of barriers each being positioned between an adjacent anode and cathode; and
a plurality of interconnects electrically connecting said plurality of the cell units.

13. The single-chamber solid oxide fuel cell system of claim 12 further comprising a mixed ionic and electronic conductor on the second surface of the electrolyte.

14. The single-chamber solid oxide fuel cell system of claim 13 wherein said mixed ionic and electronic conductor comprises lanthanum strontium cobalt ferric oxide (LSCF), or barium strontium cobalt ferric oxide (BSCF).

15. The single-chamber solid oxide fuel cell system of claim 12 wherein said electrolyte comprises two or more layers that are made of different electrolyte materials.

16. The single-chamber solid oxide fuel cell system of claim 15 wherein one of said two or more electrolyte layers is made of doped ceria and positioned adjacent to said anodes and said cathodes.

17. The single-chamber solid oxide fuel cell system of claim 12 wherein said barrier is made of a material that is inert to a fuel-oxidant mixture.

18. The single-chamber solid oxide fuel cell system of claim 12 wherein said barrier is made of an electrolyte material.

19. The single-chamber solid oxide fuel cell system 12 further comprising a support on which the electrolyte is formed.

20. The single-chamber solid oxide fuel cell system 19 wherein said support is porous, and said electrolyte comprises multiple layers that are made of different electrolyte materials.

21. A method of making a single-chamber solid oxide fuel cell stack, the method comprising the steps of:
providing a substrate of an electrolyte material having a first surface and a second surface;
applying a plurality of cell units on the first surface of the substrate, wherein each of said cell units comprises:
an elongate anode current collector; a plurality of spaced apart anodes connected to a side of the anode current collector, said plurality of anodes being substantially in parallel with a predetermined distance between adjacent anodes;
an elongate cathode current collector; a plurality of spaced apart cathodes connected to a side of the cathode current collector, said plurality of cathodes being substantially in parallel with a predetermined distance between adjacent cathodes, wherein each pair of adjacent cathodes are interdigitated with a pair of adjacent anodes, forming a plurality of anode-cathode pairs; and
a plurality of barriers each being positioned between an adjacent anode and cathode; and
co-sintering the substrate and the plurality of cell units in a same step.

22. The method of claim 21 further comprising the step of applying interconnects electrically connecting the plurality of the unit cells after the step of co-sintering.

23. The method of claim 21 further comprising the step of providing a mixed ionic and electronic conductor on the second surface of the electrolyte.

24. The method of claim 21 in which said substrate is prepared by ceramic processing.

25. The method of claim 21 wherein said substrate comprises two or more layers of different electrolyte materials, and is prepared by iso-static lamination of the two or more layers.

26. The method of claim 21 wherein said plurality of cell units are applied by spray-coating, screen-printing, microtransfer molding, microcontact printing, micromolding in capillaries (MIMIC), or vacuum-assisted microfluidic lithiography.

27. The method of claim 21 in which said co-sintering step is carried out at a temperature ranging from 1000° C. to 1500° C.

28. The method of claim 21 in which the co-sintering step is carried out at a temperature ranging from 1100° C. to 1250° C.
